(19) United States
(12) Patent Application Publication
(10) Pub. No.: US 2002/0155956 A1
(43) Pub. Date: Oct. 24, 2002

(54) Aqueous drilling fluid and shale inhibitor

(75) Inventors: Don Chamberlain, Houston, TX (US); Jim Masikewich, Calgary (CA); Carl Thaemlitz, Katy, TX (US)

Correspondence Address: ROBERT C. SHADDOX, ESQ., 2400 BANK ONE CENTER, 910 TRAVIS STREET, HOUSTON, TX, 77002, US

(73) Assignee: Newpark Drilling Fluids, L.L.C., Houston, TX

(21) Appl. No.: 10/177,986

(22) Filed: Jun. 21, 2002

Related U.S. Application Data
(62) Division of application No. 09/498,058, filed on Feb. 4, 2000, now abandoned.

(51) Int. Cl. C09K 7/00

(52) U.S. Cl. 507/100

(57) ABSTRACT

The present invention comprises the use of hexamethylene diamine (HMDA) and its salts formed with organic or inorganic acids as an inhibitor for shales and clay found in drilling and producing petroleum oil and gas wells. When HMDA is added to the aqueous base of a drilling fluid, the resultant mixture inhibits shale and clays to impart and/or increase permanent permeability stability in reservoirs. Thus, with the use of the present invention, a more environmentally acceptable, chloride free, water base drilling fluid may be used in place of an oil base drilling fluid, or fluid with the heretofor more commonly used potassium additives. The present invention may be used as a completion fluid, and as a drill-in fluid.

### GENERAL DESCRIPTION

The present invention is based in part on the discovery that by adding hexamethylene diamine (HMDA) and its salts formed with organic or inorganic acids to the aqueous base of a drilling fluid, the resultant mixture inhibits shale and clays to impart and/or increase permanent permeability stability in reservoirs. Thus, with the use of the present invention, a more environmentally acceptable, chloride free, water base drilling fluid may be used in place of an oil base drilling fluid, or fluid with the heretofor more commonly used potassium additives. The present invention may be used as a completion fluid, and as a drill-in fluid. As used in the specification and claims a drill-in fluid is a fluid used to drill through the pay zone of a reservoir.

It is well recognized in the field or the present invention that it is desirable to formulate drilling, drill-in, and completion fluids for a particular application.

The invention described herein comprises the use of HMDA as an inhibitor in water based drilling fluids, invert oil based drilling fluids and as a completion fluid specially tailored water base fluids particularly suitable for drilling in sandstone reservoirs containing swelling clay. Products comprising the HMDA inhibitor have been marketed under the trade name Hi Perm™. The present invention provides exceptional shale inhibition as well as the ability to impart and/or increase permanent permeability stability in reservoirs.

Drilling mud or drilling fluid is a more-or-less complex mixture of chemicals used in drilling of a well to perform a variety of functions. Drilling mud comprises a liquid or slurry that is pumped down the drill string to exit through nozzles in the bit immediately adjacent the formation being penetrated. The drilling mud flows upwardly in the annulus between the drill string and the wall of the hole to the surface and provides a variety of functions. The drilling mud cools and lubricates the bit, delivers hydraulic horsepower to the bit, carries cuttings upwardly in the hole during circulation, suspends the cuttings in the bore hole when circulation stops, prevents blowouts, minimizes water loss into permeable formations, lubricates between the drill string and the bore hole wall and performs assorted other functions. There are all sorts of drilling muds The most elementary drilling mud is water mixed with drilled solids and is often called “native” drilling mud Some of the drilled solids are clays which, when finely ground, provide several of the functions of drilling mud. Some of the drilled solids add weight to the slurry which raises the density of mud to 9 2-9.9 #/gallon which is sufficient to control normal pressures at shallow depths in many actively drilled areas.

Native mud was the earliest used in the rotary drilling of oil and gas wells. It was soon discovered that native drilling mud provides almost no control over the loss of water into permeable formations, tends to wash out or enlarge the diameter of the hole, accumulate shale balls on the bit and have other major disadvantages. Since that time, a wide variety of chemicals have been added to drilling mud to overcome real or perceived problems with native drilling mud.

Almost all water based drilling muds start off with water to which gel or bentonite is added and to which drilled solids become entrained. Glucorine base fluids do not require bentonite. The standard drilling mud in many areas of the world is now a native drilling mud to which has been added bentonite, sodium hydroxide, chrome lignosulfonate and lignite. In the event greater weight is needed, a particulate weighting material is added, such as barium sulfate, hematite, calcium carbonate, silica or the like. This type of drilling mud is now being supplanted by a native drilling mud-bentonite-sodium hydroxide mixture to which is added a liquid polymer chemical.

One desirable characteristic of a drilling mud is that it sets up or gels, within the well bore. This characteristic is desirable so that cuttings or weight material in the drilling mud don't fall by gravity through the drilling mud toward the bottom of the hole when circulations stops This characteristic is imparted to drilling mud by a gelling agent, such as drilled solids, bentonite and/or subbentonitic clays or mixtures thereof.

Another desirable characteristic of a drilling mud is that it creates a filter cake of low permeability on the face or permeable formations. Preferably, the filter cake should be relatively thin and hard as opposed to thick and gooey. As will be appreciated by those skilled in the art, the filter cake is created because the pressure in the bore hole exceeds the pressure in a permeable formation penetrated thereby and liquid from the mud is moved into the permeable formation, leaving on the face of the formation a filter cake comprising the solids entrained in the mud. The liquid lost to the formation is called filtrate. When a large amount of filtrate passes across the formation face, a thick filter cake is deposited. When a small amount of filtrate passes across the formation face, a thin filter cake is deposited. One function of the filter cake is to limit additional filtrate loss into the formation after the filter cake is created. A wide variety of chemicals have been used to produce thin filter cakes,or reduce filtrate loss, such as carboxy-methyl cellulose, lignite, lignosulfonates, Resinex—previously available from Magcobar, Miltemp—a high temperature polymyer previously available from Milpark, Claytemp—polymer available from Barclay, Soltex—an asphalt based material available from Drilling Specialities and the like.

One purpose of a good filter cake is to reduce the quantity of filtrate lost to a permeable formation which is desirable for two reasons First, a large amount of filtrate in the formation can affect the characteristics of many electric logs Second, there is a danger of the filtrate causing materials in the permeable formation to swell, thereby reducing the permeability of a possibly productive formation to an extent where the formation will not produce successfully. A freshwater filtrate, for example, causes many clays such as montmorillonite and illite to swell

Sodium hydroxide is added to many drilling muds to raise the pH thereof. As will become more fully apparent hereinafter, most pre-existing muds to which the additives of this invention are used are quite alkaline because sodium hydroxide has usually been added thereto.

Drilling of a typical well begins by using a so called “spud” mud. In most situations, spud mud is prepared by pumping highly treated mud from a previous well into a vacuum truck and watering it down with sufficient water to make it thin. Sometimes, spud mud is prepared by mixing bentonite in water so the resultant suspension contains 25-30# of bentonite per barrel of water

After the surface hole is drilled and cased, the surface shoe and cement are drilled, followed by drilling out under surface. Either before drilling the hole or at some deeper depth where it is decided to mud up, the additives of this invention are mixed with the preexisting mud. On occasion, it may be that there is sufficient gelling agent, i.e. drilled solids, bentonite, subbentonitic clays, and mixtures thereof, in the mud. In this event, a solution of glycerine and defoamer is simply added to the mud.

The volume of a mud system is the sum of the volume of the hole and the volume of the mud tanks or pits. The volume of a mud tank or pit is usually assumed to be constant even though they partially fill up with drilled solids during the course of drilling a well. The volume of the hole increases substantially with drilling because the hole gets deeper Thus, the volume of mud in a mud system has to increase during the course of drilling a well or the mud tank or pit will run dry Accordingly, liquid is more-or-less continuously added to a mud system. In an ordinary water based drilling mud, liquid is added by allowing a stream of water from a water hose to flow into the mud return line or across the shale shaker In maintaining a mud system of this invention, water is added conventionally but liquid additives are prepared and placed in a tank of adequate size, e.g. a frac tank, and periodically pumped into the mud tank.

This is conveniently accomplished by providing a compressed air driven pump which is operated by a timer. The mud engineer clocks the item necessary to fill a five gallon bucket from the pump. Based on the analysis of the mud and the increase in hole volume it may necessitate the daily addition of some volume of a glucorine-defoamer solution. The mud engineer determines this needed volume addition and leaves instructions for each driller to operate the compressed air driven pump for a predetermined number of minutes each tour, thereby adding the necessary volume of glucorine-defoamer solution as needed.

In a typical drilling well, a mud engineer conducts a variety of analyses on the drilling mud at frequent intervals, at least once a day. In the course of these tests, it is often determined that the sampled mud is deficient in one or more respects and appropriate corrective action is taken. In the mud system of this invention, there are usually only five things to do: (1) control the amount of gelling agent to be sure there is enough to carry drilled solids to the surface and provide sufficient gel strength to suspend solids if circulation is stopped; (2) control the filter loss of the mud by adding a filter loss reducer; (3) control the amount of glucorine-defoamer solution; (4) maintains the desired mud weight by adding weight material if necessary; (5) keeps the amount of solids suspended in the system under control by using mud cleaning equipment such as a mud centrifuge, cyclone or the like, and (6) ensure that the proper alkalinity of the fluid is maintained.

There are numerous patents relating to oil well fluids and drilling fluids. A few examples are U.S. Pat. Nos: 2,375,616; 3,750,768 to Suman, Jr. et al., 3,937,678 to Yasuda et al., 4,128,436 to O'Hara et al., 4,776,966 to Baker; 5,710,108 to McNally et al.; 5,710,110 to Cooperman et al ; and, 5,969,006 to Onan et al.

U.S. Pat. No. 2,375,616 relates to the use of organic amines in water-based drilling fluids to prevent the hydration and the sloughing of shales.

U.S. Pat. No. 5,710,108 to McNally et al. teaches a biopolymer/oil suspension composition for oil well fluids including drilling fluids which comprises one or more hydrocarbon oils, one or more biopolymers and an anti-settling agent which may be one or more polyamide and hydrogenated castor oil. Suitable polyamine compounds include 1,6-hexamethylene diamine which is preferably combined with a hydrogenated castor oil such as castor wax.

U.S. Pat. No. 5,710,110 to Cooperman relates to an oil well fluid anti-settling additive comprising a mixture of one or more reaction products of one or more tertiary polyalkoxylated aliphatic amino compounds and one or more organic compounds selected from the group consisting of maleic anhydride, phthalic anhydride and mixtures thereof and one or more Theologically active clay-based materials. Discussed as prior art relevant to this invention at column 7, lines 25 to 39 is Japanese Patent Application No. 62-69957 which discloses a sag preventer for non-aqueous coating materials comprising a mixture of two different fatty acid amides wherein fatty acid amides A and B reaction products that may be derived from HMDA.

U.S. Pat. No. 4,776,966 to Baker shows a drilling fluid composition of the invert oil-based type incorporating a block or graft copolymer and dispersing agent derived from a polyalk(en)ylsuccinic anhydride. The dispersing agent may comprise a reaction product between the anhydride and a polyamide such as HMDA.

U.S. Pat. No. 3,750,768 to Suman, Jr. et al. teaches the use of the ketimine reaction product of HMDA and a ketone as a latent curing agent for an epoxy resin that functions to consolidate a permeable water-containing earth formation. The reaction products of a hydrogenated castor oil fatty acid with a primary or secondary amine such as HMDA are, utilized in U.S. Pat. No. 3,937,678 to Yasuda et al. to improve rheological properties and suspension properties of a nonaqueous fluids system containing finely divided solid particles. Similar reaction products are taught in U.S. Pat. No. 4,128,436 to O'Hara et al.

U.S. Pat. No. 5,969,006 to Onan et al. shows the use of hardening agents for epoxy resins comprising unreacted amines and polyamines such as triethylenetetramine, ethylenediamine and the like.

It is apparent that there is a wide knowledge base and considerable expertise in the art for formulating drilling fluids and compositions for drilling fluids for production zones an possible production zones. The patents described above ( U.S. Pat. Nos. 2,375,616; 3,750,768; 3,937,678; 4,128,436; 4,776,966; 5,710,108; 5,710,110; and 5,969,006) are each hereby specifically incorporated by reference.

### DETAILED DESCRIPTION

The present invention encompasses the use of hexamethylene dramine and its salts formed with organic or inorganic acids (e.g. HCI or monocarboxylic acids) in an aqueous base of a drilling fluid for production zones and possible production zones. The purpose of HMDA is to inhibit shales and clays to impart and/or increase permanent permeability stability in reservoirs. It may also be used to inhibit shale during gravel packing operations or other completion methods The composition works in a manner similar to potassium, in that it's hydrated diameter fits neatly between clay layers, effectively dehydrating the clay. As the clay dehydrates, the void volume within the pore system increases, resulting in a permeability increase. Unlike potassium, HMDA is divalent-making it difficult to leach out.

The ability to prevent particles of water sensitive, mixed layer shales from losing their physical integrity in water-based drilling fluids may be controlled by several methods. Two of these methods are the encapsulation of the shale particles with a water-soluble polymer and the modification of the ironic chemistry of the shale to prevent its layers from dissociating or dispersing.

Dispersion is not necessarily dependent on the hydration of the shale particles; therefore, care must be taken when interpreting data from tests and investigations. Dispersion relates to the crumbling tendency of the shale, which may be inhibited or enhanced by chemicals that prevent the shale from hydrating.

The use of organic amines in water-based drilling fluids to prevent the hydration and the sloughing of shales has been documented in the literature for years (e.g. U.S. Pat. No. 2,375,616). Brief examples of three classes of amine structures commonly used for shale inhibition are expressed herein.

1. Primary [H₂N—R], secondary [H—NR₂], and tertiary amines [NR₃]. When these materials are added to the alkaline environment of a water-based drilling fluid they are present as nonionic materials; however, the electron-rich nitrogen atom creates a region of somewhat negative polarity within the molecule. Clay surfaces that are positively charged may form a complex with this polar portion of the amine molecule, which in turn results in a modification of the surface of the clay. This surface modification may cause a significant effect in how the clay particles are attracted to one another. These changes may be manifested as flocculation, deflocculation, or hydration inhibition of the clay.

The material Hi Perm™ is the difunctional primary amine [H₂N—R—NH₂] hexamethylene diamine (HMDA) that has been neutralized with formic acid. Upon addition to an alkaline, water-based drilling fluid the formate anion is released and the HMDA is free in solution.

2. Amino acids. These compounds may be represented by the general structure H₂N—R—COO in most alkaline, water-based drilling fluids. Such a molecule possesses a nonionic, polar amine group and an anionic carboxylic acid group. Amino acids exhibit what is known as an isoelectric point that is a different value for each compound. The isoelectric point occurs at a specific hydrogen ion concentration at which the general structure presented above changes to its quaternary ammonium salt [H₃N—R—COOH]. Many amino acids exhibit an isoelectric point in the pH range from 6 0-8 0 This class of materials may also be referred to as amphoteric shale inhibitors. The term amphoteric refers to the chemical structure of the isoelectric point transition state [H₃N—R—COO].

3. Quaternary amines. These compounds differ from quaternary ammonium salts in that they have four carbon-nitrogen bonds and always possess a cationic charge regardless of the pH of the solution that they are in [NR₄⁺X]. Methylene blue is a quaternary amine, for example. Quaternary Amines are quite efficient in their capabilities to displace metal cations from shales. Their efficiency is dependent on their molecular weight, which may vary from monomeric and monofunctional to polymeric

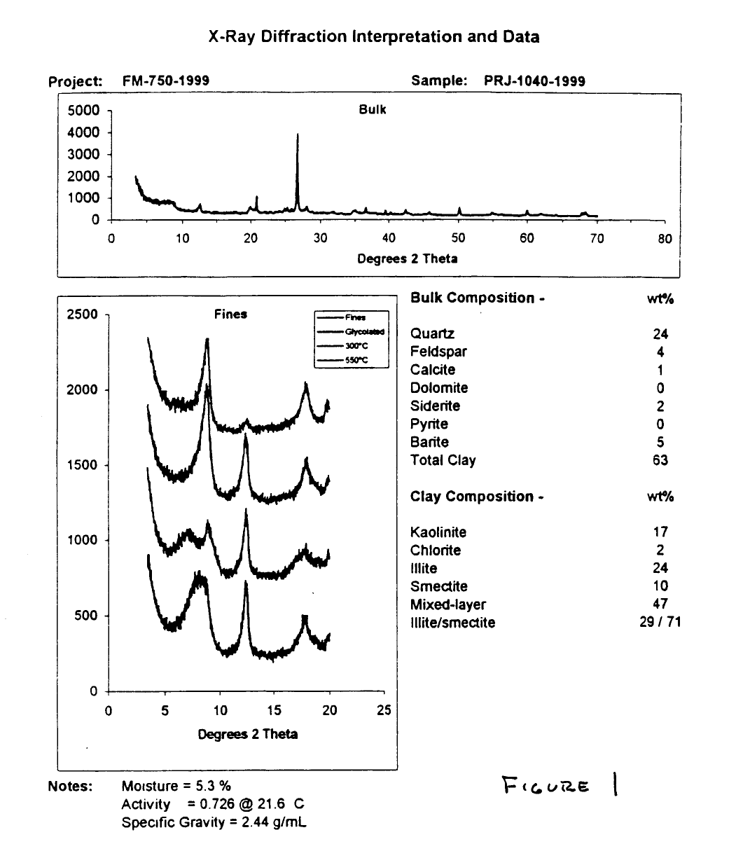

A laboratory test was conducted to investigate the dispersion inhibition properties of the shale inhibitor of the present invention relative to those of potassium chloride and another inhibitor of known properties and performance marketed as Deep Drill Inhibitor (DDI). The cuttings used in this test had been exposed to stresses caused by drilling with a PDC bit. This pre-stressed state of the shale must be kept in mind when drawing conclusions relating cuttings properties to those of the unstressed formation. The cuttings used were from an invert emulsion drilling fluid used on British Borneo's well Prime Lee #1. Mineralogical analyses appear as FIG. 1.

The cuttings were cleaned in hexane and dried thoroughly. Owing to their water reactivity, the shale cuttings were investigated in he following two manners:

1. Hydration suppression additives in tap water. Solutions having volumes of 350 ml each were prepared as displayed in Table 1. Shale cuttings sized greater than 14 mesh were added in the quantities shown in Table 1 to each solution and aged while rolling at 150° F. for 16 hours. After the samples were cooled to ambient temperature, they were poured through a 45 mesh screen and the retained cuttings were washed with 350 ml of tap water. The recovered cuttings samples were dried at 225° F. to constant weight.

2. Hydration suppression additives in tap water containing an encapsulating polymer. This testing procedure is basically the same as outlined above, with the procedural modification of treating each fluid with two grams of PHPA (Alcomer 120, Allied Colloids) before the addition of the inhibitors or cuttings.

Another laboratory test was conducted to determine the ability of hexamethylene diamine (HMDA) in an aqueous base (denoted as Hi Perm in the accompanying figures) to inhibit the swelling of bentonite clay, and to compare the bentonite swelling inhibition capabilities of Hi Perm™ to those of potassium chloride. 200 g of tap water and a known quantity of a shale inhibitor were added to clean class jars Untreated API bentonite was added to each jar in 10 g quantities per day and rolled at 150° F. for a minimum of 16 hours before studies were carried out. This procedure was carried out until all the testing fluids became too viscous to study.

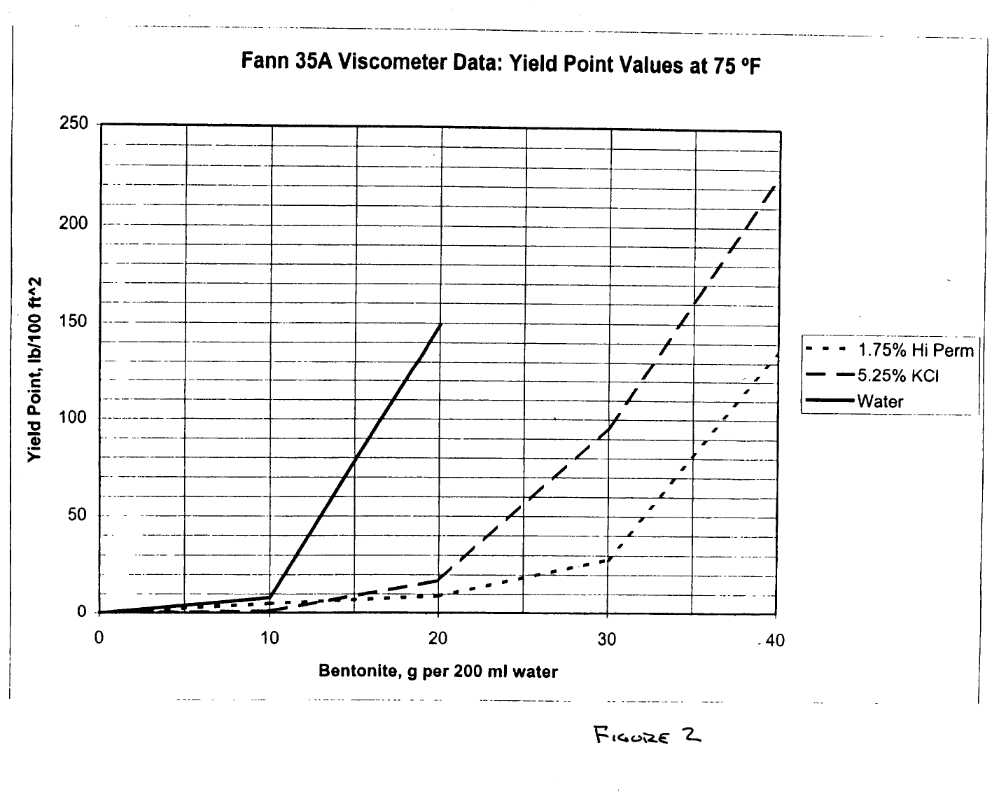

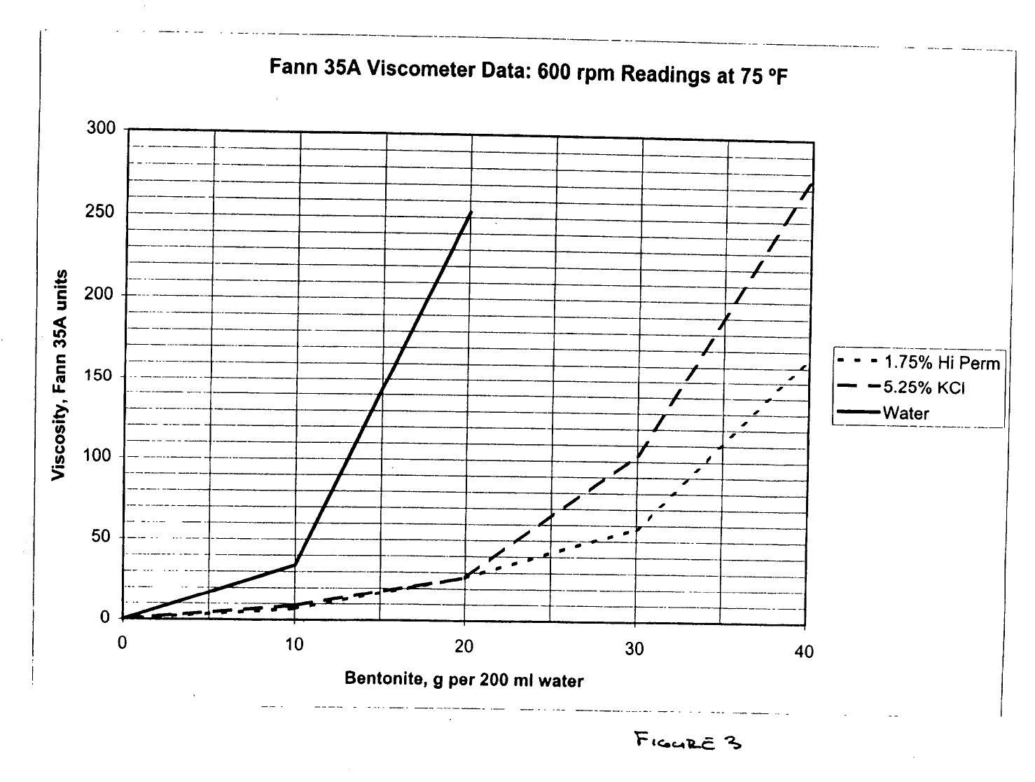

FIGS. 2 and 3, respectively, give the Fann 35A Viscometer Data Yield Point Values at 75° F., and Viscometer Data 600 rpm Readings at 75° F. Tables 2 and 3 present the data from the test In summary, observation of the tap water presented normal hydration, 5.25% (w/w) KCl indicated a normal appearance with no flocculation, but the 1.75% (w/w) Hi Perm present bentonite that was highly flocculated an settled to the bottom of the jar. The flocks wee large and somewhat adhering to the glass of the jar. The bentonite exhibited a light gray and “dry” appearance typical of the inhibition properties observed for quaternary ammonium compounds.

The present invention thus has proved to be a highly effective hydration suppressant when compared to the performance of potassium chloride. The invention displays the desirable property of creating minimal flocculation when compared to the properties of many organic shale inhibitors. Visual observations indicate the invention hydrophobically modifies the bentonite particles.

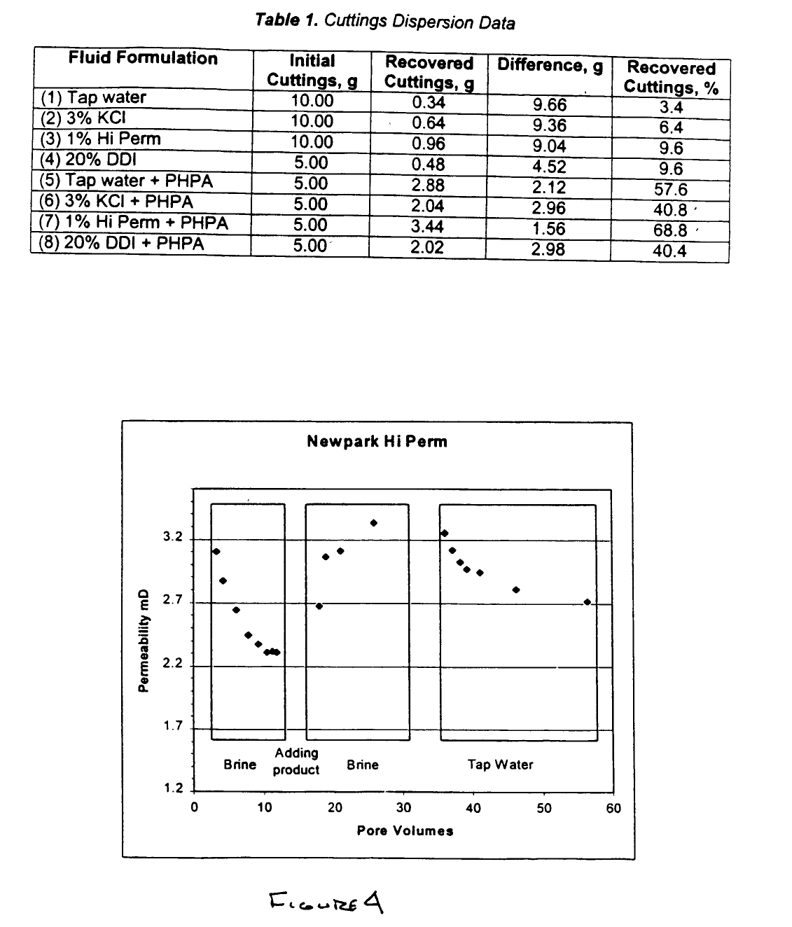

The present invention is a chloride free, clay inhibitor that is 100% soluble in water. It is a clear liquid. The invention imparts a permanent permeability increase in sandstone reservoirs containing swelling clay. FIG. 4 shows the results of a clay-swelling test using the invention, marketed as Newpark Hi Perm™. In the test a “Cardium” sandstone core plug was restored to in situ water saturation and wettability. It was mounted in a holder where overburden stress, pressures and temperatures were simulated. Reservoir brine was passed through the core plug until a baseline permeability was established. Several pore volumes of brine containing Newpark Hi Perm™ were then passed through the plug. The product works in a manner similar to potassium, in that it's hydrated diameter fits neatly between clay layers, effectively dehydrating the clay. As the clay dehydrates, the void volume within the pore system increases, resulting in a permeability increase. Unlike potassium, Newpark Hi Perm™ is divalent-making it difficult to leach out. In the test, when fresh water is finally passed through the plug, the permeability remains higher than the brine baseline that was initially established. If the clay had been dehydrated with potassium, the fresh water would have eventually reduced the permeability to below the original brine baseline value.

Added benefits of the present invention include: biodegradability; non-oil wetting; non-foaming; low toxicity; and multiple absorption sites. As discussed above drilling fluids and specific additives are designed or engineered for a specific site and application. The range of concentrations envisioned for the present invention for the wide variety of applications is from as low as 0.1% up to 6.0% by volume. Concentrations used in the field for most applications will be 0.3% to 3.0% by volume. The invention is effective in any pH range, however increased concentrations will be required above pH of 10.5. The invention marketed as Newpark Hi Perm™ comes in 201 plastic pails, 32 pails per pallet. The product can be added directly to the mud system either on surface or through the mixing system. Monitoring in the field is easily accomplished. Due to its unique structure, analysis of High-Perm by a direct method is possible. This method is able to distinguish between total High-Perm concentrations and available High-Perm concentrations using standard mud kit apparatus. For most purposes, determining available High-Perm concentrations should be sufficient. If residual concentrations of High-Perm are much lower than expected determining the total concentration of High-Perm will aid in assessing whether the product is being consumed down-hole or in the drilling solids. Newpark Hi Perm™ has been implemented in both under-balanced (foam) applications and overbalanced horizontal wells.

In the examples and throughout this specification, and in the other references, the following abbreviations may be used API=American Petroleum Institute water loss; cp=centipoise ° C.=degrees Centrigrade; ° F.=degrees Fahrenheit; %=percent; cc=cubic centimeters; cm=centimeter; l=liter; sec=seconds; ft=feet; min=minute; psi=pounds per square inch; kg/m³=kilograms per cubic meter; mg/l-milligrams per liter; g=grams; lb/100 ft²=pounds per 100 square feet; lb/bbl or ppb=pounds per 42 gallon barrel; w/w=weight over weight; min=minute; YP=yield point; PV=plastic viscosity; MG=methyl glucoside; hsi=horsepower per square inch; HTHP=High Temperature High Pressure filtration test; MBT=Methylene Blue Test; P_{f}=p-alkalinity filtrate; Mf=m-alkalinity filtrate; Pm=p-alkalinity mud; Dynabse W=Starch; DynaNite=Gilsonite; Gypsum=Calcium Sulfate; Lime=Calcium Hydroxide; New Bar=Barium Sulfate; Dyna Soar=PHP, polyacrylamide, polyacrylate; NewLig=lignite; NewPac=Polyanion Cellulose derivative; NewXan=Xanthan Gum; DynaPlex.

As to the manner of operation and use of the present invention, the same is made apparent from the foregoing discussion. With respect to the above description, it is to be realized that although an enabling embodiment is disclosed, the enabling embodiment is illustrative, and the optimum relationships for the steps of the invention and calculations are to include variations in proportions, sequences, materials, components, and manner of operation, mixture and use, which are deemed readily apparent to one skilled in the art in view of this disclosure, and all equivalent relationships to those illustrated and described in the specifications are intended to be encompassed by the present invention.

Therefore, the foregoing is considered as illustrative of the principles of the invention and since numerous modifications will readily occur to those skilled in the art, it is not desired to limit the invention to the exact components and proportions and operations shown or described, and all suitable modifications and equivalents may be resorted to, falling within the scope of the invention.

What is claimed as being new and desired to be protected by Letters Patent is as follows:

[image]

[image]

What is claimed is:

1. In a drilling fluid comprising an aqueous phase, wherein the aqueous phase includes hexamethylene diamine solubilized therein.

2. The drilling fluid of claim 1, wherein the hexamethylene diamine comprises not less than 0.1% by volume of the drilling fluid.

3. The drilling fluid of claim 1, wherein the hexamethylene diamine comprises not more than 6.0% by volume of the drilling fluid.

4. The drilling fluid of claim 1, wherein the hexamethylene diamine comprises not less than 0.1% by volume of the drilling fluid and not more than 6.0% by volume of the drilling fluid.

5. The drilling fluid of claim 1, wherein the hexamethylene diamine comprises not less than 0.3% by volume of the drilling fluid.

6. The drilling fluid of claim 1, wherein the hexamethylene diamine comprises not more than 3.0% by volume of the drilling fluid.

7. The drilling fluid of claim 1, wherein the hexamethylene diamine comprises not less than 0.3% by volume of the drilling fluid and not more than 3.0% by volume of the drilling fluid.

8. A fluid for use in petroleum wells, comprising water, and hexamethylene diamine.

9. The drilling fluid of claim 8, wherein the hexamethylene diamine comprises not less than 0.1% by volume of the drilling fluid.

10. The drilling fluid of claim 8, wherein the hexamethylene diamine comprises not more than 6.0% by volume of the drilling fluid.

11. The drilling fluid of claim 8, wherein the hexamethylene diamine comprises not less than 0.1% by volume of the drilling fluid and not more than 6.0% by volume of the drilling fluid.

12. The drilling fluid of claim 8, wherein the hexamethylene diamine comprises not less than 0.3% by volume of the drilling fluid.

13. The drilling fluid of claim 8, wherein the hexamethylene diamine comprises not more than 3.0% by volume of the drilling fluid.

14. The drilling fluid of claim 8, wherein the hexamethylene diamine comprises not less than 0.3% by volume of the drilling fluid and not more than 3.0% by volume of the drilling fluid.

15. In a drill-in fluid comprising an aqueous phase, wherein the aqueous phase includes hexamethylene diamine solubilized therein.

16. The drill-in fluid of claim 15, wherein the hexamethylene diamine comprises not less than 0.1% by volume of the drilling fluid.

17. The drill-in fluid of claim 15, wherein the hexamethylene diamine comprises not more than 6.0% by volume of the drilling fluid.

18. The drill-in fluid of claim 15, wherein the hexamethylene diamine comprises not less than 0.1% by volume of the drilling fluid and not more than 6.0% by volume of the drilling fluid.

19. The drill-in fluid of claim 15, wherein the hexamethylene diamine comprises not less than 0.3% by volume of the drilling fluid.

20. The drill-in fluid of claim 15, wherein the hexamethylene diamine comprises not more than 6.0% by volume of the drilling fluid.
